(19) United States
(12) Patent Application Publication
(10) Pub. No.: US 2010/0250502 A1
(43) Pub. Date: Sep. 30, 2010

(54) METHOD AND APPARATUS FOR CONTENTS DE-DUPLICATION

(76) Inventor: Kiyokazu SAIGO, San Jose, CA (US)

Correspondence Address: MATTINGLY & MALUR, P.C., 1800 DIAGONAL ROAD, SUITE 370, ALEXANDRIA, VA, 22314, US

(21) Appl. No.: 12/412,771

(22) Filed: Mar. 27, 2009

(51) Int. Cl. G06F 17/30; G06Q 30/00; G06Q 50/00

(52) U.S. Cl. 707/692; 705/34; 707/E17.005; 707/E17.014; 707/E17.032

(57) ABSTRACT

Exemplary embodiments provide in effect data de-duplication in storage servers without the need to compare every byte of stored data. In one embodiment, a method for providing contents from a content device to a storage device comprises receiving by a storage device a ticket including trade information of a trade by a user for content from a content device; receiving by the storage device from the content device attribute information of the content identified in the ticket; determining whether the storage device has the content identified in the ticket based on the attribute information; if the storage device does not have the content identified in the ticket, receiving the content identified in the ticket from the content device and storing the content in the storage device; and if the storage device has the content identified in the ticket, not receiving the content identified in the ticket from the content device.

### BACKGROUND OF THE INVENTION

The present invention relates generally to storage systems and, more particularly, to data de-duplication in storage servers.

An IT system is now a mandatory component of companies to carry out their everyday business. Because the IT system becomes larger and more complex, however, the cost to design, build, and manage the IT system dramatically increases year by year. Furthermore, for a company which has an application system (e.g., a web ticketing system) that encounters spiky increases of transaction workload in a short period of time although it does not have much workload in general time wise, it is very costly to build and manage the large IT system based on its maximum workload amount.

To provide the required amount of IT resources elastically or flexibly in order to handle those temporary and drastic increases in workload, “cloud service” providers have emerged. They offer services for companies or end users to utilize the required amount of IT resource via the Internet, which has been built and is managed at cloud service providers' datacenter, to be paid by the time and amount utilization of resources. Actually, “application service providers” were in existence before; however, due to the lack of network bandwidth, for instance, such service business was not widely accepted in those early days. In accordance with the innovation of improved network speed, and also the emergence of virtual server and storage technologies enabling more dynamic provisioning of IT resources, business application outsourcing via the Internet is being offered in more realistic latency and price. Therefore, the cloud service provider market has become a reality and it continues to grow.

Examples of cloud service providers include those outsourcing technology of IT system via the Internet with usage based payment, such as Amazon Web Services (http://aws.amazon.com), Google App Engine (http://code.google.com/intl/en/appengine), and Salesforce.com/Force.com (https://www.salesforce.com/platform/). An example of monitoring I/O throughput of cloud service is Hyperic CloudStatus (http://www.cloudstatus.com). An example of virtual server management technologies is VMware virtual server management products (http://www.vmware.com/products/vi/vc/, http://www.vmware.com/products/vi/vc/vmotion.html).

Data de-duplication is increasingly more important for storage servers, because many users utilize storage servers to keep more and more data. “Cloud Storage” is an example of storage servers and is used by many users to store their data. In addition, online businesses that sell contents such as movies, music, pictures, and the like have become popular. Customers buy contents from the online businesses and download the contents to their PCs and other electronic devices.

For storage servers, data de-duplication will become more important. On the other hand, large amounts of CPU resources are required to execute data de-duplication, because it is necessary to compare all bytes information of stored data. In addition, it is a waste of bandwidth to transfer contents from the Contents Server to the Storage Server via the Client PC. It is better to send the contents directly from the Contents Server to the Storage Server. Further, it is better not to send contents if the Storage Server already has the same contents.

### BRIEF SUMMARY OF THE INVENTION

Exemplary embodiments of the invention provide in effect data de-duplication in storage servers with reduced disk areas. The storage servers can enjoy the benefit of data de-duplication without the need to compare every byte of stored data. In addition, the contents servers with reduced bandwidth can be used. In one embodiment, storage servers run data de-duplication before they store data. When users buy contents from contents servers, they store the contents in storage servers. The contents servers send attribute information of the contents to the storage servers in advance, and the storage servers make a judgment as to whether they already have the same contents. If the storage servers do not have the same contents, the storage servers download the contents to the storage servers. Otherwise, the storage servers do not download the contents to the storage servers. The storage servers update the contents management tables which they have. In effect, contents data are de-duplicated when they are stored in the storage servers. In this way, the storage servers can cut down disk areas, and can enjoy the benefit of data de-duplication without comparing every byte of stored data. The contents servers can cut down bandwidth.

In accordance with an aspect of the invention, a method for providing contents from a content device to a storage device comprises receiving by a storage device a ticket including trade information of a trade by a user for content from a content device; receiving by the storage device from the content device attribute information of the content identified in the ticket; determining whether the storage device has the content identified in the ticket based on the attribute information; if the storage device does not have the content identified in the ticket, receiving the content identified in the ticket from the content device and storing the content in the storage device; and if the storage device has the content identified in the ticket, not receiving the content identified in the ticket from the content device.

In some embodiments, the determining comprises referring to a content management table which stores a content ID of each content stored in the storage device and one or more users who possess said each content. The method further comprises updating the content management table using the trade information on the ticket. Receiving the ticket comprises receiving the ticket from the content device which issues the ticket based on an order from a client device that provides, to the content device, information on the storage device for storing the content identified in the ticket. The method further comprises authenticating the user by providing billing information of the user to the content device prior to issuing the ticket by the content device.

In specific embodiments, the content device is selected by the storage device from a plurality of content devices which include one or more of content servers and cache servers that have the content identified in the ticket. The content device may be selected based on at least one of a bandwidth of the content device or a network distance between the content device and the storage device. Receiving the content identified in the ticket comprises receiving a plurality of divided sub-contents that make up the content.

In accordance with another aspect of the invention, a system for providing contents comprises a content device which issues a ticket including trade information of a trade by a user for content from the content device; a storage device which receives the ticket; and a network connecting the content device and the storage device. The storage device receives attribute information of the content identified in the ticket; and determines whether the storage device has the content identified in the ticket based on the attribute information. If the storage device does not have the content identified in the ticket, the storage device receives the content identified in the ticket from the content device and storing the content in the storage device. If the storage device has the content identified in the ticket, the storage device does not receive the content identified in the ticket from the content device.

Another aspect of the invention is directed to a computer-readable storage medium storing a plurality of instructions for controlling a data processor to provide contents from a content device to a storage device. The plurality of instructions comprise instructions that cause the data processor to receive, by the storage device, a ticket including trade information of a trade by a user for content from the content device; instructions that cause the data processor to request, by the storage device, attribute information of the content identified in the ticket from the content device; instructions that cause the data processor to determine whether the storage device has the content identified in the ticket based on the attribute information; if the storage device does not have the content identified in the ticket, instructions that cause the data processor to receive the content identified in the ticket from the content device and store the content in the storage device; and if the storage device has the content identified in the ticket, instructions that cause the data processor not to receive the content identified in the ticket from the content device.

These and other features and advantages of the present invention will become apparent to those of ordinary skill in the art in view of the following detailed description of the specific embodiments.

### BRIEF DESCRIPTION OF THE DRAWINGS

FIG. 1 shows an example of a hardware configuration of a server.

FIG. 2 shows an example of a hardware configuration of a NAS system.

FIG. 3 illustrates an example of a hardware configuration of a computer system in which the method and apparatus of the invention may be applied according to the first embodiment of the invention.

FIG. 4 shows an example of a flow diagram of data and information among the Contents Server, Storage Server, and Client PC according to the first embodiment of the invention.

FIG. 5 shows an example of a flow diagram of data and information among the Contents Server, Storage Server, and two Client PCs.

FIG. 6 shows an example of a process flow chart of the Storage Server.

FIG. 7 shows an example of a Buyer Management Table according to the first embodiment of the invention.

FIG. 8 shows an example of a Contents Management Table.

FIG. 9 shows an example of a ticket that is sent from the Client PC to the Storage Server.

FIG. 10 shows an example of a flow diagram of data and information among the Contents Server, Storage Server, and Client PC according to the second embodiment of the invention.

FIG. 11 shows an example of a Buyer Management Table according to the second embodiment of the invention.

FIG. 12 illustrates an example of a hardware configuration of a computer system in which the method and apparatus of the invention may be applied according to the third embodiment of the invention.

FIG. 13 shows an example of a flow diagram of data and information among the Authentication Server, Contents Server, Storage Server, and Client PC according to the third embodiment of the invention.

FIG. 14 shows an example of a Client Management Table.

FIG. 15 illustrates an example of a hardware configuration of a computer system in which the method and apparatus of the invention may be applied according to the fourth embodiment of the invention.

FIG. 16 shows an example of a flow diagram of data and information among the Authentication Server, Cache Server1 Contents Server, Storage Server, and Client PC according to the fourth embodiment of the invention.

FIG. 17 shows an example of the information which is sent from the Contents Server to the Storage Server.

FIG. 18 illustrates an example of a hardware configuration of a computer system in which the method and apparatus of the invention may be applied according to the fifth embodiment of the invention.

FIG. 19 shows an example of a flow diagram of data and information among the Contents Server, Storage Server, and Client PC according to the fifth embodiment of the invention.

FIG. 20 shows an example of a Divided Contents Management Table.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment”, “this embodiment”, or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing”, “computing”, “calculating”, “determining”, “displaying”, or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for providing in effect data de-duplication in storage servers with reduced disk areas.

### 1. First Embodiment

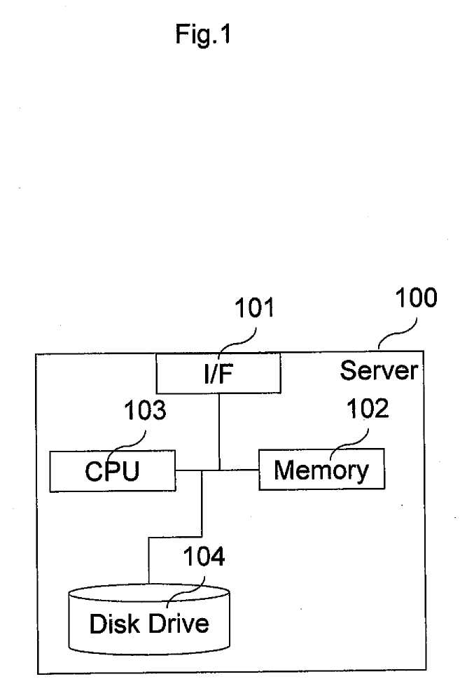

FIG. 1 shows an example of a hardware configuration of a server 100. The server 100 includes an interface 101, a memory 102, a CPU 103, and a disk drive 104. The server 100 is connected to a network through the interface 101. The network is a LAN, WAN, MAN, or the like. Programs are stored in the disk drive 104, loaded on the memory 102, and executed by the CPU 103.

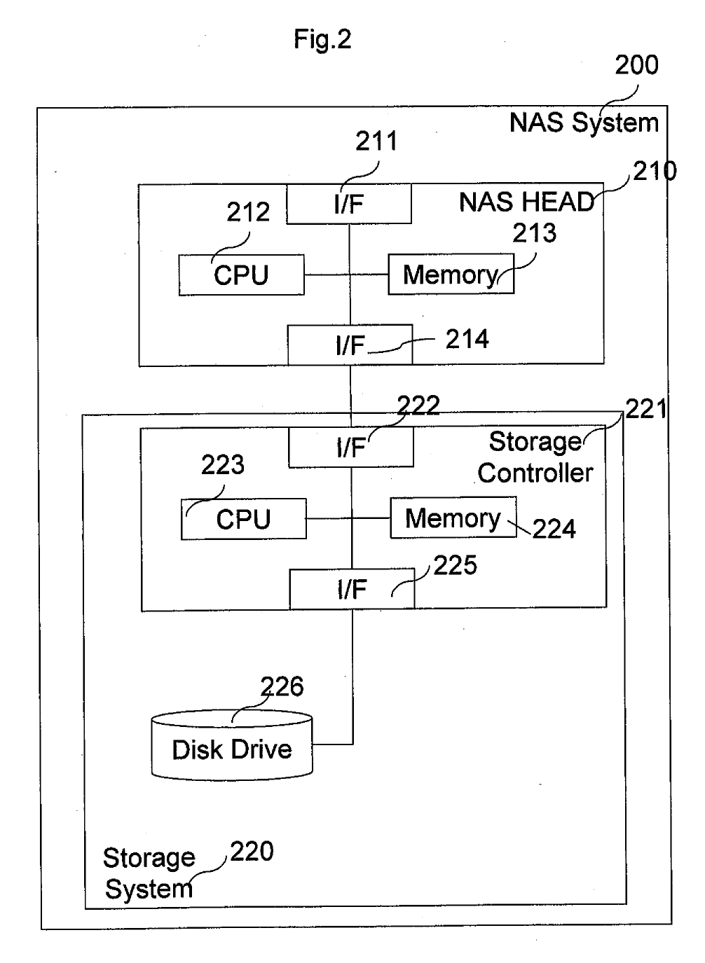

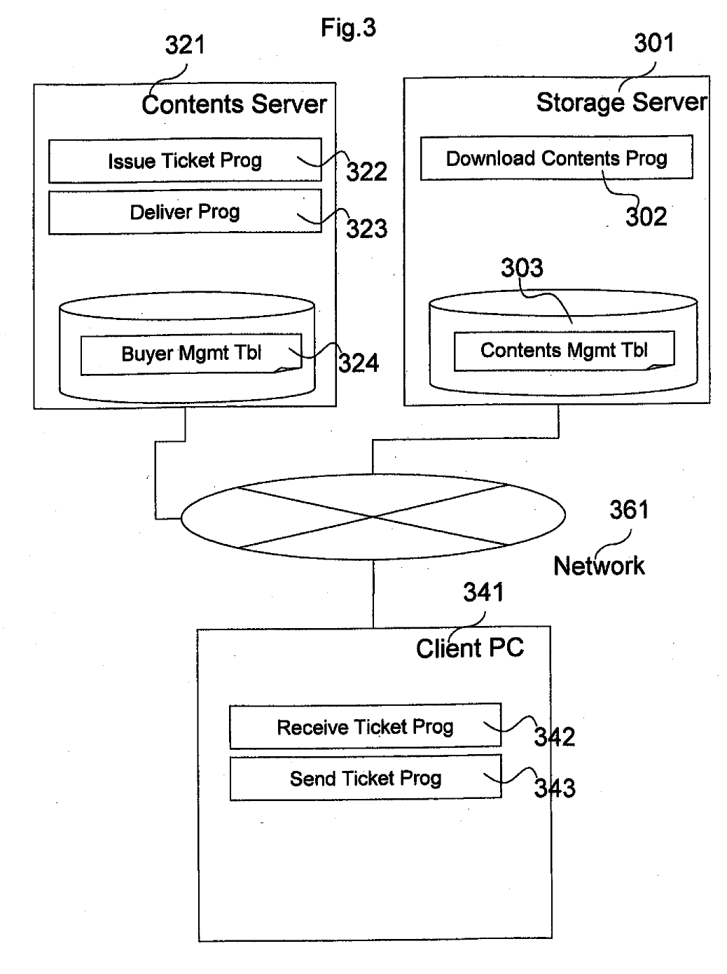

FIG. 2 shows an example of a hardware configuration of a NAS (network-attached storage) system 200. The NAS system 200 is one example of a storage server (301 in FIG. 3). The NAS system 200 includes a NAS head 210 and a storage system 220. The NAS Head 210 includes a first interface 211, a CPU 212, a memory 213, and a second interface 214. The NAS head 210 is connected to a network through the first interface 211. The network is a LAN, WAN, MAN, or the like. Programs are stored in the storage system 220, loaded on the memory 213, and executed by the CPU 212. The NAS head 210 is connected to the storage system 220 via the second interface 214. The storage system 220 includes a storage controller 221 and a disk drive 226. The storage controller 221 includes a first interface 222, a CPU 223, a memory 224, and a second interface 225. The storage controller 221 is connected to the NAS head 210 via the first interface 222. Programs are stored in the disk drive 226, loaded on the memory 224, and executed by the CPU 223. The storage controller 221 is connected to the disk drive 226 via the second interface 225.

FIG. 3 illustrates an example of a hardware configuration of a computer system in which the method and apparatus of the invention may be applied according to the first embodiment of the invention. The system includes a Storage Server 301, a Contents Server 321, a Client PC 341, and a Network 361. The Storage Server 301, Contents Server 321, and Client PC 341 are connected via the Network 361. The Network 361 may be a LAN, WAN, MAN, or the like.

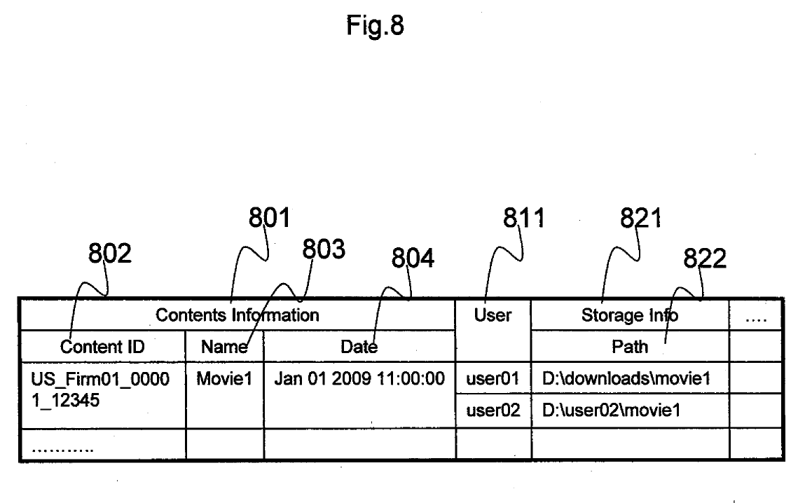

The Storage Server 301 has a data area in which a plurality of users store their data. The Storage Server 301 has a Download Contents Program 302 and a Contents Management Table 303. The Download Contents Program 302 downloads contents from the Contents Server 321. The Client PC 341 may input contents server information about the Contents Server 321 and contents information which the client bought from the Contents Server 321. The Contents Management Table 303 has information about contents stored in the Storage Server 301 and its buyer(s). This table information is described in FIG. 8.

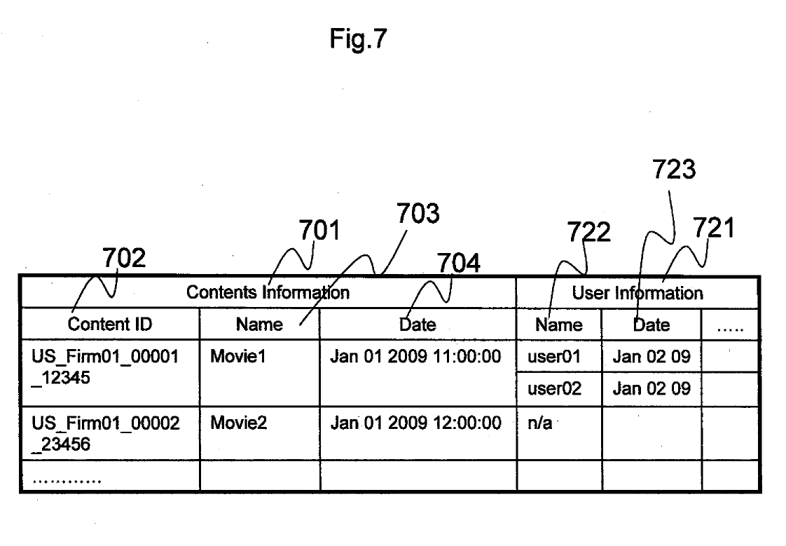

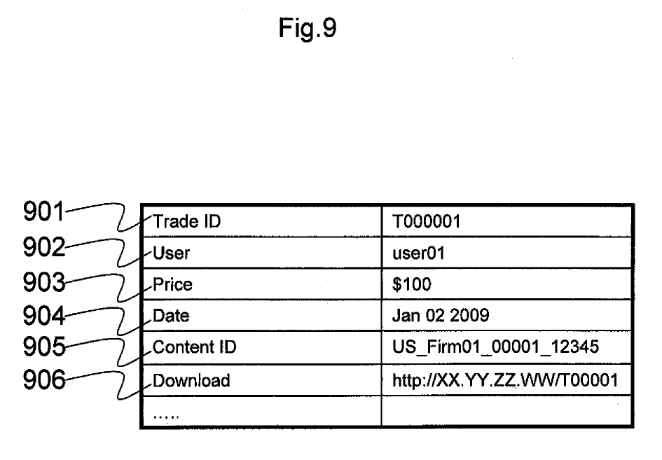

The Contents Server 321 has contents such as movies, videos, pictures, music, and so on. A client accesses the Contents Server 321 and buys contents. The Contents Server 321 has an Issue Ticket Program 322, a Deliver Program 323, and a Buyer Management Table 324. The Issue Ticket Program 322 issues tickets when a client buys contents. This ticket has the information of the trade, client, and contents which the client bought. This ticket information is described in FIG. 9. With this ticket, the Storage Server 301 downloads contents from the Contents Server 321. The Deliver Program 323 delivers contents to the Storage Server 301. The Storage Server 301 requests contents using the ticket information, and the Contents Server 321 deliver contents in response to the request. The Buyer Management Table 324 has the information of the contents buyer. This information is described in FIG. 7.

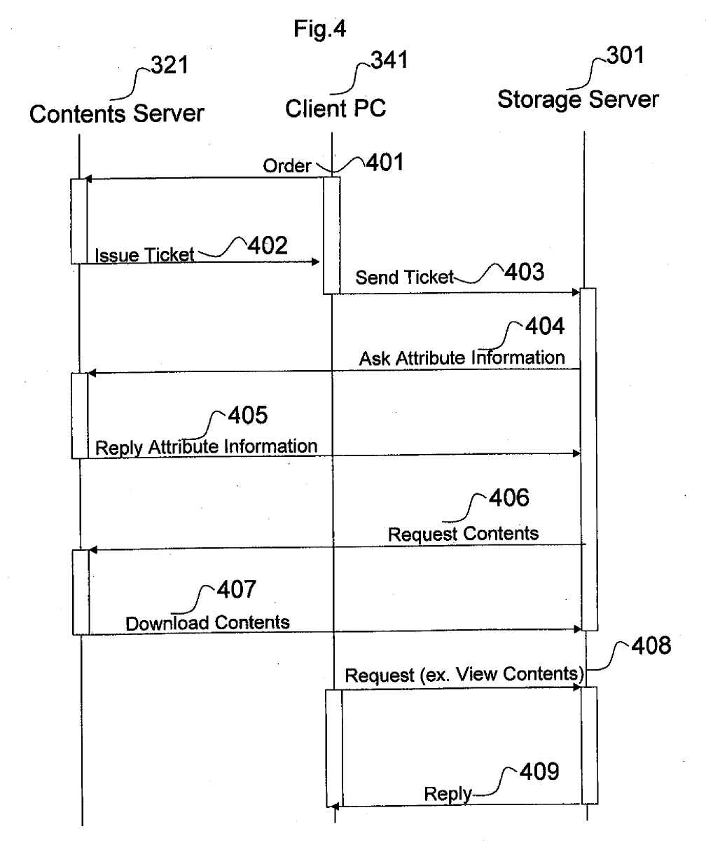

The Client PC 341 has a Receive Ticket Program 342 for receiving a ticket (from the Contents Server 321 at step 402 of FIG. 4) and a Send Ticket Program 343 for sending a ticket (to the Storage Server 301 at step 403 of FIG. 4).

FIG. 4 shows an example of a flow diagram of data and information among the Contents Server 321, Storage Server 301, and Client PC 341 according to the first embodiment of the invention. At step 401, the Client PC 341 orders contents from the Contents Server 321. At step 402, the Contents Server 321 issues a ticket to the Client PC 341. This ticket has the trade information of the purchase. The ticket information is described in FIG. 9. In addition, the Contents Server 321 may send the contents to the Client PC 341. At step 403, the Client PC 341 sends the ticket to the Storage Server 301. This ticket information is described in FIG. 9. With this ticket information, the Storage Server 301 requests contents from the Contents Server 321. At step 404, the Storage Server 301 first asks for attribute information of the contents from the Contents Server 321. At step 405, the Contents Server 321 checks the request and the Buyer Management Table 324, and sends a reply with the attribute information of the contents to the Storage Server 301. At step 406, the Storage Server 301 requests contents from the Contents Server 321, if the Storage Server 301 does not already have the contents. To determine whether it has the contents or not, the Storage Server 301 uses the attribute information which Contents Server 321 sends. At step 407, the Contents Server 321 delivers the requested contents to the Storage Server 301. The Contents Server 321 uses the Buyer Management Table 324, and determines whether it should send the requested contents or not. At step 408, the Storage Server 301 receives a request from the Client PC 341 such as a request to view the contents therein. At step 409, the Storage Server 301 responds by sending a reply to the Client PC 341.

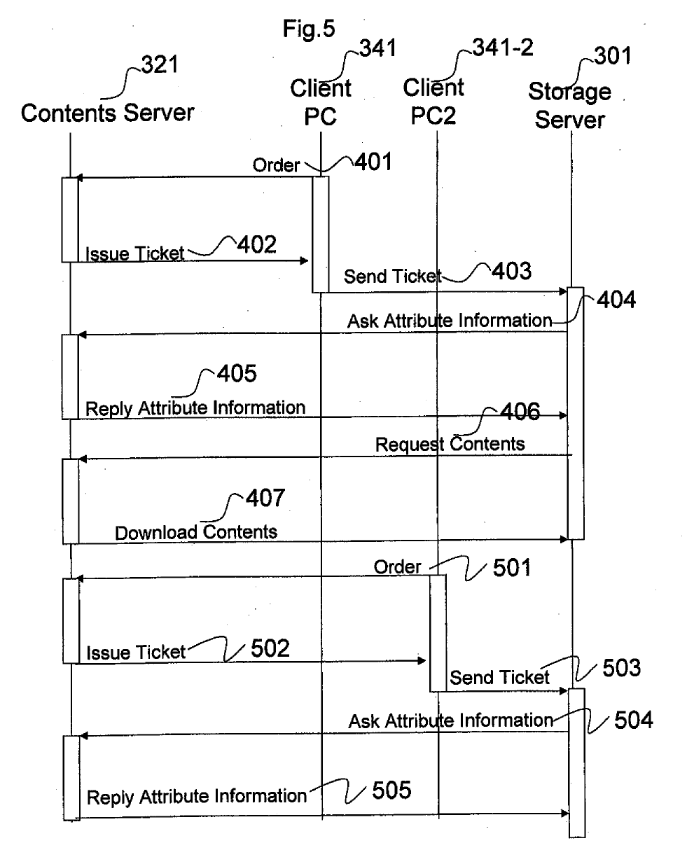

FIG. 5 shows an example of a flow diagram of data and information among the Contents Server 321, Storage Server 301, and two Client PCs 341 and 341-2. This figure explains how the Storage Server 301 works when another user or client buys the same contents which the Storage Server 301 already has.

Step 401 to step 407 are the same as those in FIG. 4. At step 501, the second Client PC2 341-2 orders the same contents that the first Client PC 341 has ordered. At step 502, the Contents Server 321 issues a ticket to the Client PC2 341-2. This step is similar to step 402. At step 503, the Client PC2 341-2 sends the ticket to the Storage Server 301. This step is similar to step 403. At step 504, the Storage Server 301 asks for attribute information of the content. This step is similar to step 404. At step 505, the Contents Server 321 sends a reply with attribute information to the Storage Server 301. This step is similar to step 405. Next, the Storage Server 301 decides whether to request the contents from the Contents Server 321. In this case, the Storage Server 301 finds that the contents Client PC2 341-2 orders are the same contents as those that Client PC 231 has ordered, and the Storage Server 301 already has the same contents. Thus, the Storage Server 301 does not request the contents from the Contents Server 321, and it updates the Contents Management Table 303.

The Contents Server 321 and Storage Server 301 enjoy the benefits as described below. First, the Contents Server 321 does not need to provide a very wide bandwidth. The Contents Server 321 would need to prepare a very wide bandwidth if the Contents Server 321 were to send every content ordered to the Storage Server 301. Some of the contents are already stored in the Storage Server 301, when several users use the same Storage Server 301 and there is a possibility that some of them order the same contents. It is a waste of bandwidth to send the same contents repeatedly in such circumstances as described above. Cutting down bandwidth leads to cost savings. Second, the Storage Server 301 does not need to provide a very large disk area. The Storage Server 301 can enjoy the same benefits, if the Storage Server 301 executes data de-duplication. However, a lot of CPU resources are required to execute data de-duplication. The amount of data stored in the Storage Server 301 will continue to increase. As a result, more CPU resources will be required over time. It will become more and more difficult to compare all the stored data. In such circumstances, it will become important to compare data before the Storage Server 301 stores them, and to store de-duplicated data.

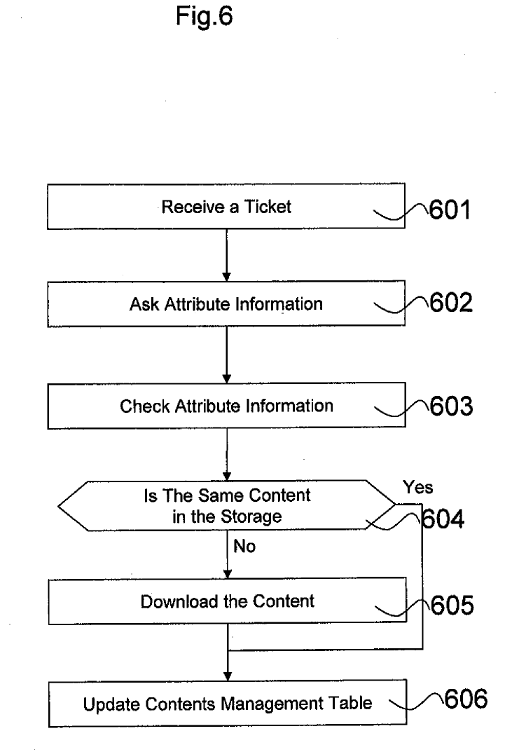

FIG. 6 shows an example of a process flow chart of the Storage Server 301. At step 601, the Storage Server 301 receives a ticket. A ticket has information about the contents being bought and the buyer, and this buyer is a user of the Storage Server 301. The ticket information is described in FIG. 9. This ticket may be sent to the Storage Server 301 by the Client PC 341 or Contents Server 321. At step 602, the Storage Server 301 asks the Contents Server 321 for attribute information of the contents listed on the ticket. The attribute information includes “Content ID” and other contents information. At step 603, the Storage Server 301 receives the attribute information and checks the information. At step 604, the Storage Server 301 determines whether the same content is stored in the Storage Server 301. If the same content is already stored in the Storage Server 301, the Storage Server 301 proceeds to step 606. If the same content is not stored in the Storage Server 301, the Storage Server 301 proceeds to step 605. At step 605, the Storage Server 301 downloads content from the Contents Server 321. At step 606, the Storage Server updates the Contents Management Table 303. The Contents Management Table 303 is described in FIG. 8.

FIG. 7 shows an example of a Buyer Management Table 324 according to the first embodiment of the invention. This table includes Contents Information 701 and User Information 721. The Contents Information 701 is the information of the contents which the Contents Server 321 has. The User Information 721 is the information of the user who bought contents. The Contents Information 701 includes Content ID 702, and may further include Name 703 and Date 704. The Content ID 702 is the unique identifier of the content. There are several ways of providing a descriptive ID, including, for example, 1) Country ID, 2) Company (Association/Organization) ID, 3) Content (Product) ID, and 4) Arithmetic (Hash) ID. The Content ID 702 may be a combination of the values described above and so on. The Name 703 is the content name. The Date 704 is the date information when the content was produced. In addition, the Contents Information 701 may include information on the rights to read, write, or execute (READ/WRITE/EXECUTE). The Contents Information 701 may include manager information on who has those rights (READ/WRITE/EXECUTE). The User Information 721 includes a Name 722, and may include a Date 723. The Name 722 is the buyer information of the buyer who bought the content. The Date 723 is the date when the buyer bought the content. The Contents Server 321 manages the contents and buyers' information. The Contents Server 321 updates this Buyer Management Table 324 when a user buys content. The Contents Server 321 checks this table when the Storage Server 301 requests contents, and it makes judgments regarding the request for contents.

FIG. 8 shows an example of a Contents Management Table 303. The Contents Management Table 303 has Contents Information 801, User Information 811, and Storage Information 821. The Contents Information 801 is the information of the contents which the Storage Server 301 has. The Contents Information 801 includes a Content ID 802, and may further include a Name 803 and a Date 804. These are similar to the Contents Information 701 in FIG. 7. The User Information 811 is the information of the user who possesses the content. The Storage Information 821 indicates how the contents are stored and how each user can access the contents. The Storage Information 821 may include a Path 822. The user accesses the content with this Path 822.

FIG. 9 shows an example of a ticket that is sent from the Client PC 341 to the Storage Server 301 at step 403 in FIG. 4. The ticket includes a Content ID 905 and a Download 906. The Content ID 905 is the same information as the Content ID 702 in FIG. 7 and the Content ID 802 in FIG. 8. The Storage Server 301 distinguishes the content which the client bought based on the Content ID 905. The Download 906 shows how to download the content. The Storage Server 301 utilizes this information and downloads the content from the Contents Server 321. The Download 906 may be URL information, WEB service information, authentication information, and so on. The ticket may include user information under User 902. This is the user authentication information for the Storage Server 301. The ticket may include a Trade ID 901. This is the complementary information of the trade. The Contents Server 321 may manage trade information with this Trade ID 901. On the ticket, the Date 904 and Price 903 are the complementary information of the trade.

### 2. Second Embodiment

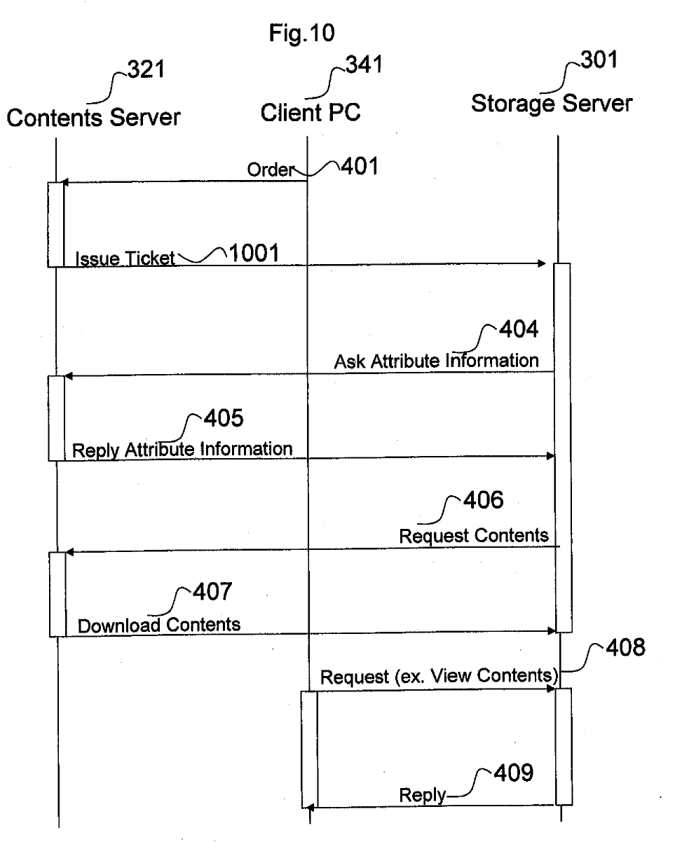

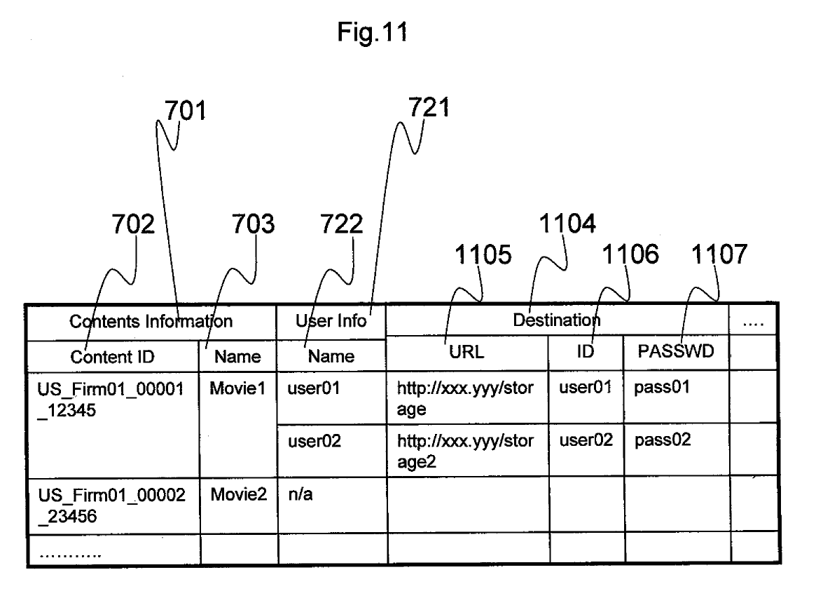

FIG. 10 shows an example of a flow diagram of data and information among the Contents Server 321, Storage Server 301, and Client PC 341 according to the second embodiment of the invention. Most of the flow steps are the same as those in FIG. 4. Only step 1001 is different. At step 1001, the Contents Server 321 directly sends the ticket to the Storage Server 301 (instead of via the Client PC 341). At step 401, the Client PC 341 inputs its storage server information to the Contents Server 321, so that step 1001 may bypass the Client PC 341. As such, some information is added to the Buyer Management Table 324. The Buyer Management Table according to the second embodiment is described in FIG. 11.

FIG. 11 shows an example of a Buyer Management Table 324 according to the second embodiment of the invention. The Contents Information 701 and User Information 721 are the same in those in FIG. 7. Destination information 1104 is added. The Contents Server 321 uses the Destination information 1104, and sends the ticket directly to the Storage Server 301 at step 1001 of FIG. 10. The Destination information 1104 includes a URL 1105, and may further include an ID 1106 and a Password 1107. The URL 1105 shows the place where the user's Storage Server 301 exists. The ID 1106 and Password 1107 are used to access the Storage Server 301.

### 3. Third Embodiment

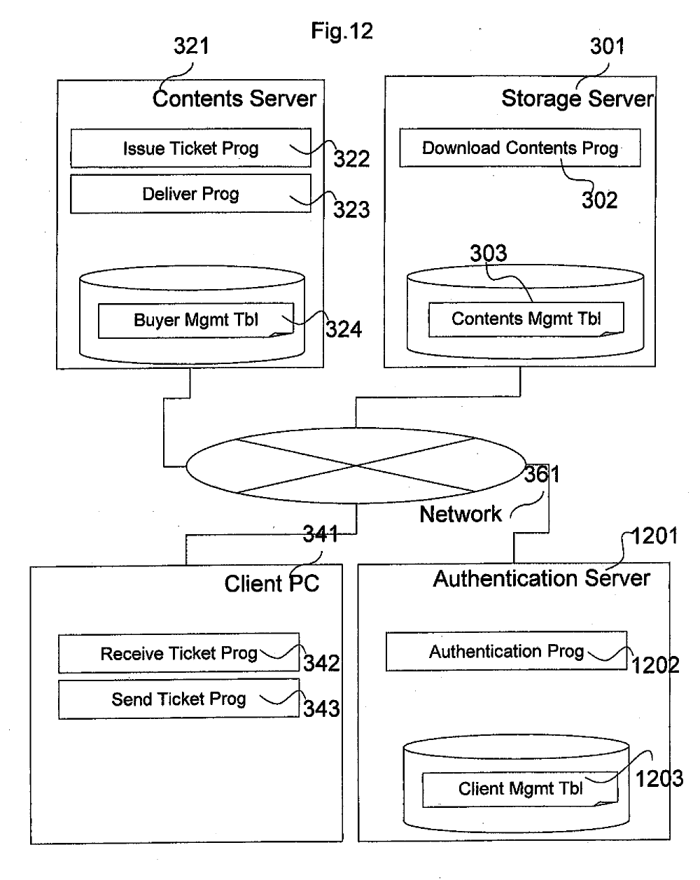

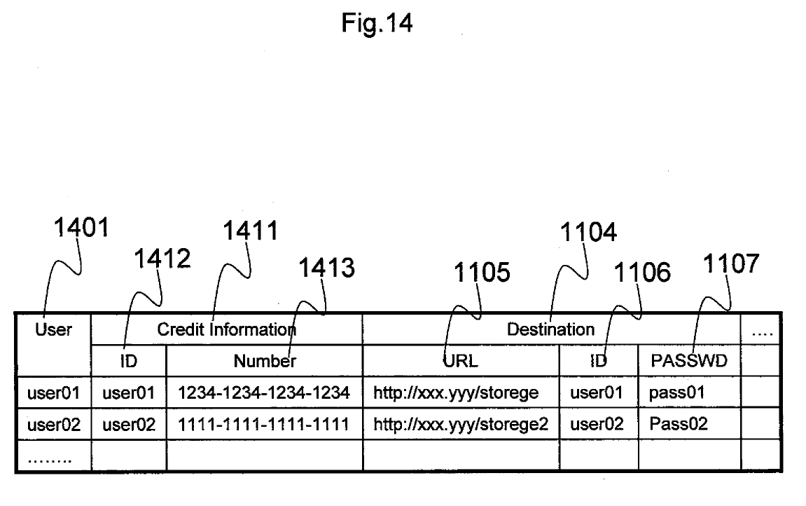

FIG. 12 illustrates an example of a hardware configuration of a computer system in which the method and apparatus of the invention may be applied according to the third embodiment of the invention. The system includes the Storage Server 301, Contents Server 321, Client PC 341, Network 361, and Authentication Server 1201. The difference between the first embodiment and the third embodiment is the additional Authentication Server 1201 which has an Authentication Program 1202 for user authentication and a Client Management Table 1203. The Client Management Table 1203 is described in FIG. 14. The Authentication Server 1201 provides billing information of users to the Contents Server 321.

FIG. 14 shows an example of a Client Management Table 1203. The Client Management Table 1203 includes User 1401 and Credit Information 1411, and may further include Destination 1104. The Credit Information 1411 includes an ID 1412 and a Number 1413, and may include expiring date information that is required for billing. The User 1401 is the user information for the Contents Server 321, and it may be the same as the ID 1412.

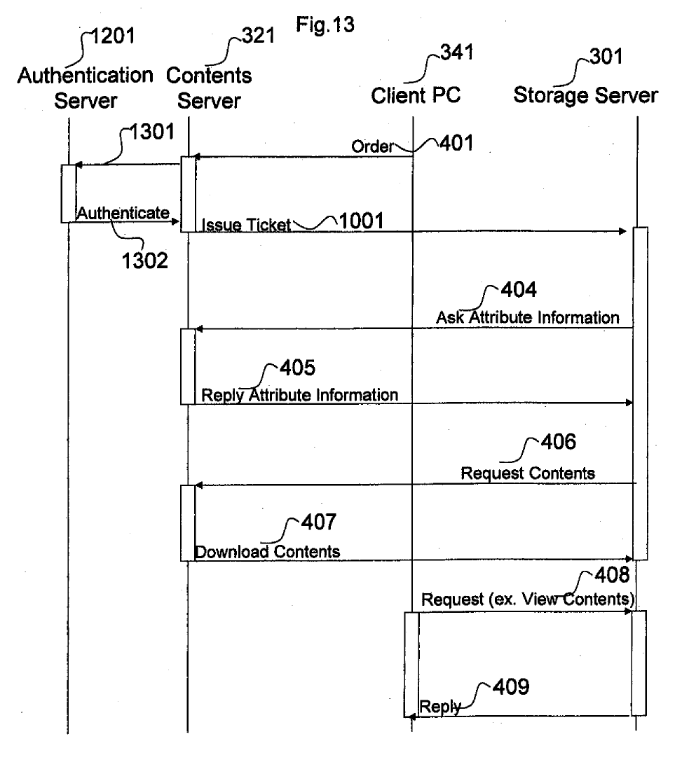

FIG. 13 shows an example of a flow diagram of data and information among the Authentication Server 1201, Contents Server 321, Storage Server 301, and Client PC 341 according to the third embodiment of the invention. Most of the flow steps are the same as those in FIG. 4. The differences are found in steps 1301 and 1302. At step 1301, the Contents Server 321 asks for authentication information from the Authentication Server 1201. At step 1302, the Authentication Server 1201 sends the authentication information to the Contents Server 321. The authentication information may include clearance information.

### 4. Fourth Embodiment

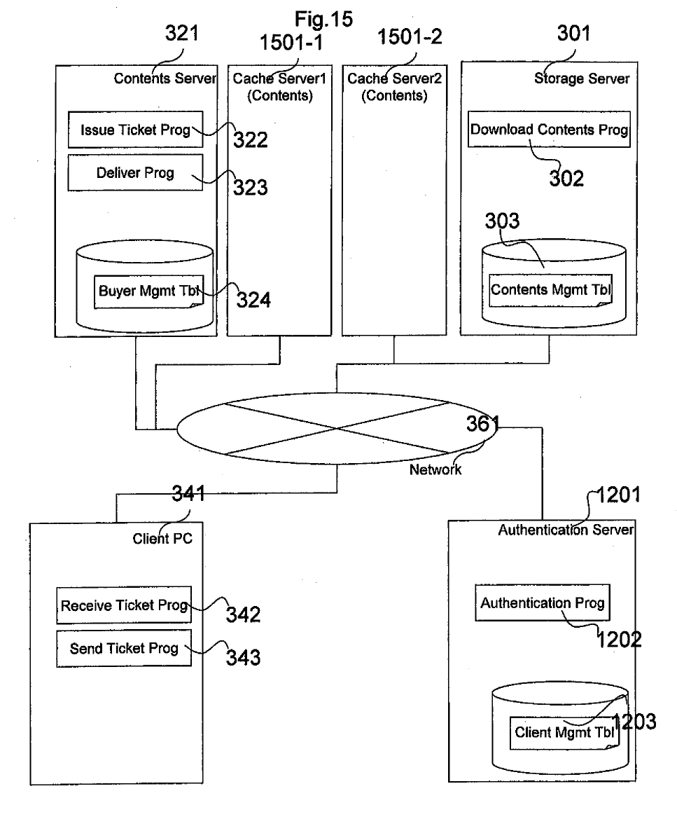

FIG. 15 illustrates an example of a hardware configuration of a computer system in which the method and apparatus of the invention may be applied according to the fourth embodiment of the invention. The system includes the Storage Server 301, Contents Server 321, Client PC 341, Network 361, Authentication Server 1201, Cache Server-1 1501-1, and Cache Server-2 1501-2. This embodiment adds two Cache Servers. Each Cache Server stores part of the contents which the Contents Server 321 has.

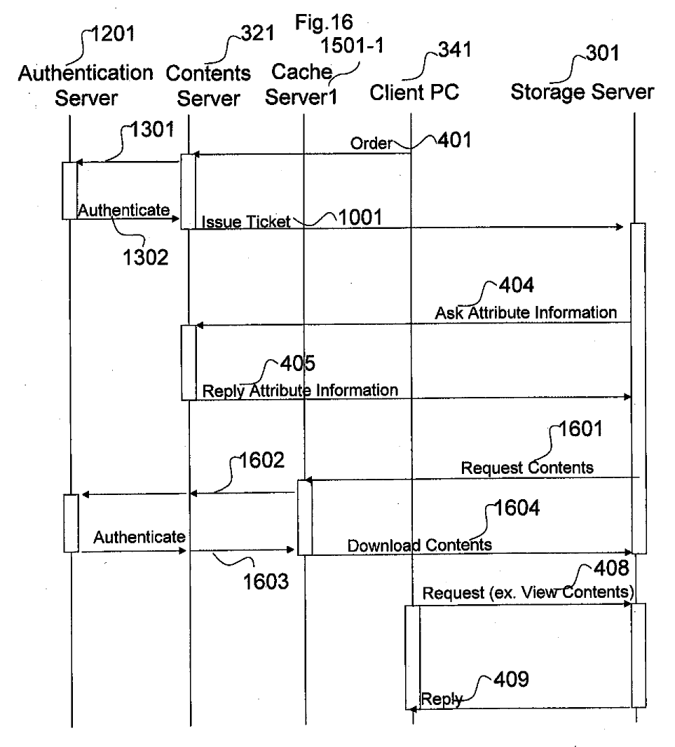

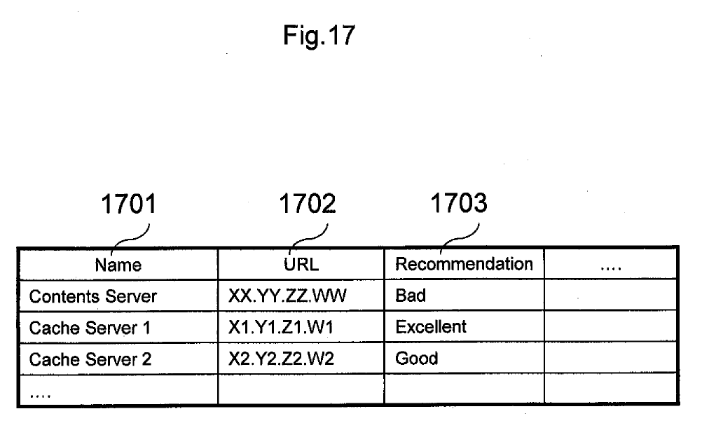

FIG. 16 shows an example of a flow diagram of data and information among the Authentication Server 1201, Cache Server1 1501-1 Contents Server 321, Storage Server 301, and Client PC 341 according to the fourth embodiment of the invention. The difference between FIG. 13 and FIG. 16 is the server which transfers contents to the Storage Server 301. At step 1601, the Storage Server 301 requests contents from the Cache Server1 1501-1. The Storage Server 301 selects the cache server among the plurality of cache servers in view of the bandwidth of cache server, network distance, and so on. At step 1604, the Cache Server1 1501-1 transfers contents to the Storage Server 301. The Cache Server1 1501-1 may use the Authentication Server 1201 for authentication before transferring the contents at step 1604. This is done at steps 1602 and 1603. At step 1602, the Cache Server1 1501-1 checks whether the request from the Storage Server 301 is valid. At Step 1603, the Authentication Server 1201 sends a response to the Cache Server1 1501-1. The Storage Server 301 selects the cache server prior to step 1601. The Contents Server 321 sends the cache server information to the Storage Server 301 at step 405. In FIG. 17, this cache server information is described.

FIG. 17 shows an example of the information which is sent from the Contents Server 321 to the Storage Server 301 at step 405 of FIG. 16. With this information, the Storage Server 301 makes judgments (i.e., selects a server among the contents server and the cache servers), and requests contents from the selected server. The table in FIG. 17 includes a Name 1701 and a URL 1702, and may further include a Recommendation 1703. The Name 1701 lists the names of servers which have contents. The URL 1702 lists the address information of the servers. The Storage Server 301 sends requests to the Contents Server/Cache Server using the address information. The Contents Server 321 recommends a server to which the Storage Server 301 may send a request for contents. The Contents Server 321 decides the level of recommendation based on certain information. For example, the Contents Server 321 considers the IP addresses, and estimates the distance between the Storage Server 301 and the cache servers. In another example, the Contents Server 321 considers the CPU loads of the cache servers. In yet another example, the Contents Server 321 considers the bandwidths of the cache servers.

### 5. Fifth Embodiment

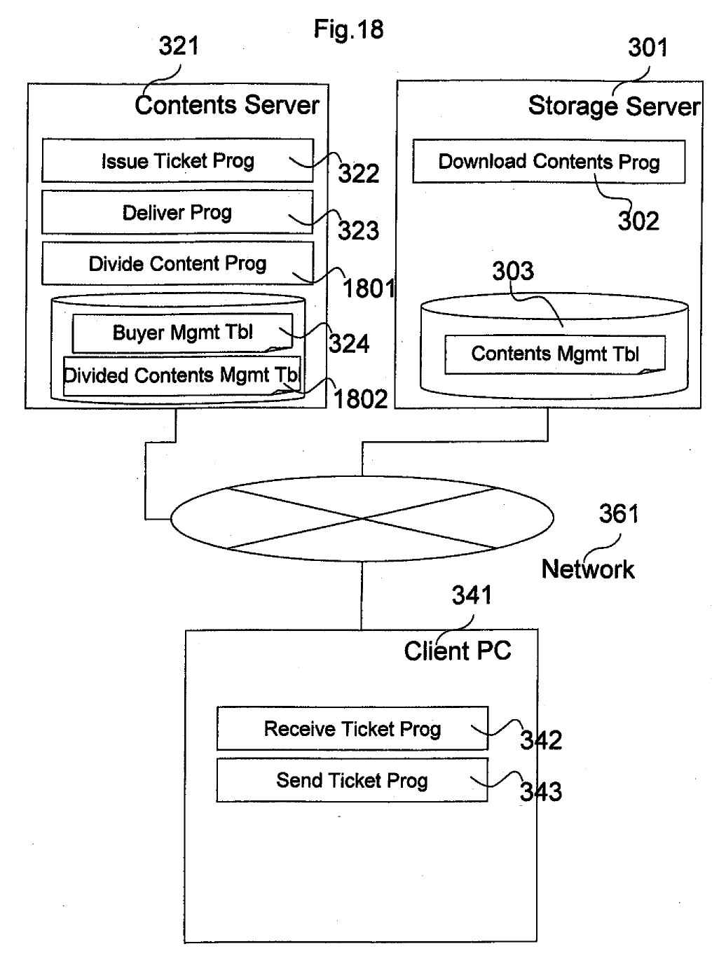

FIG. 18 illustrates an example of a hardware configuration of a computer system in which the method and apparatus of the invention may be applied according to the fifth embodiment of the invention. The system includes the Storage Server 301, Contents Server 321, Client PC 341 and Network 361. The difference between FIG. 3 and FIG. 18 is the function of the Contents Server 321. In the embodiment of FIG. 18, the Contents Server 321 has a Divide Content Program 1801. Using this program, the Contents Server 321 divides contents, and delivers divided contents to the Storage Server 301. To manage divided contents, the Contents Server 321 has a Divided Contents Management Table 1802.

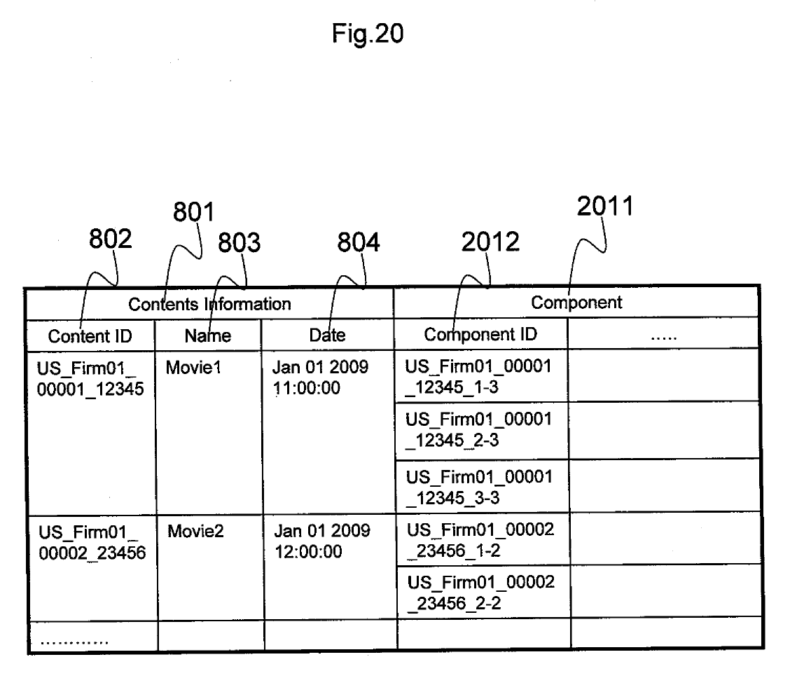

FIG. 20 shows an example of a Divided Contents Management Table 1802. This table has Contents Information 801 and Component 2011. One content is divided to several components. Each component has a Component ID 2012. The Storage Server 301 sends requests with this Component ID 2012.

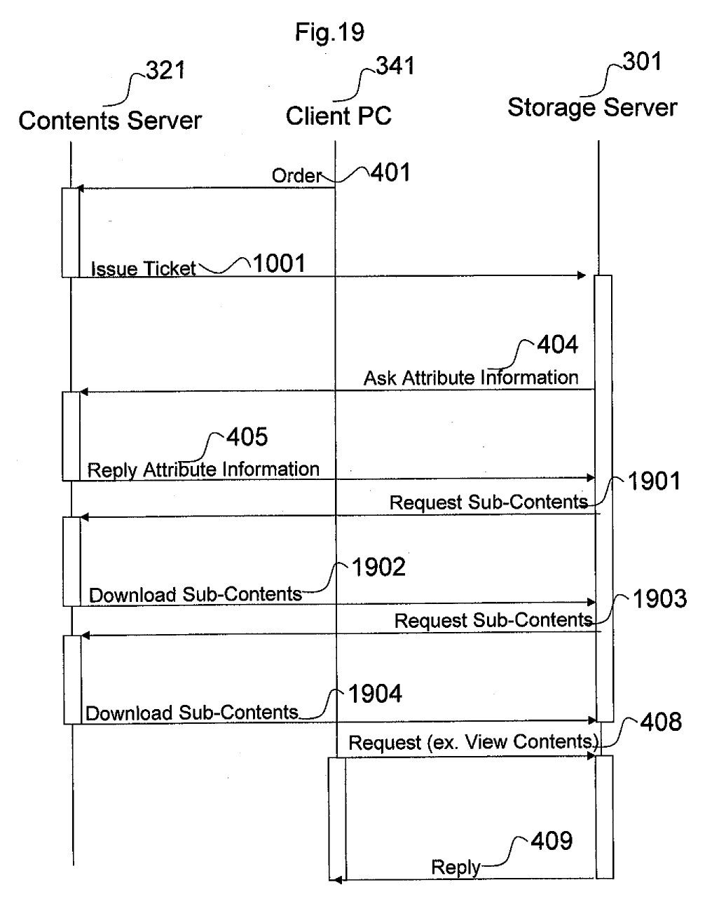

FIG. 19 shows an example of a flow diagram of data and information among the Contents Server 321, Storage Server 301, and Client PC 341 according to the fifth embodiment of the invention. The differences between FIG. 4 and FIG. 19 are steps 1901, 1902, 1903 and 1904. The Storage Server 301 requests divided contents (i.e., sub-contents) from the Contents Server 321 at steps 1901 and 1902. The Contents Server 321 sends the divided contents to the Storage Server 301 at steps 1903 and 1904.

Of course, the system configurations illustrated in FIGS. 1-3, 12, 15, and 18 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for data de-duplication in storage servers with reduced disk areas. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A method for providing contents from a content device to a storage device, the method comprising:
receiving, by a storage device, a ticket including trade information of a trade by a user for content from a content device;
receiving, by the storage device, from the content device attribute information of the content identified in the ticket;
determining whether the storage device has the content identified in the ticket based on the attribute information;
if the storage device does not have the content identified in the ticket, receiving the content identified in the ticket from the content device and storing the content in the storage device; and
if the storage device has the content identified in the ticket, not receiving the content identified in the ticket from the content device.

2. A method according to claim 1,
wherein the determining comprises referring to a content management table which stores a content ID of each content stored in the storage device and one or more users who possess said each content; and
wherein the method further comprises updating the content management table using the trade information on the ticket.

3. A method according to claim 1,
wherein receiving the ticket comprises receiving the ticket from the content device which issues the ticket based on an order from a client device that provides, to the content device, information on the storage device for storing the content identified in the ticket.

4. A method according to claim 1, further comprising:
authenticating the user by providing billing information of the user to the content device prior to issuing the ticket by the content device.

5. A method according to claim 1,
wherein the content device is selected by the storage device from a plurality of content devices which include one or more of content servers and cache servers that have the content identified in the ticket.

6. A method according to claim 5,
wherein the content device is selected based on at least one of a bandwidth of the content device or a network distance between the content device and the storage device.

7. A method according to claim 1,
wherein receiving the content identified in the ticket comprises receiving a plurality of divided sub-contents that make up the content.

8. A system for providing contents, the system comprising:
a content device which issues a ticket including trade information of a trade by a user for content from the content device;
a storage device which receives the ticket; and
a network connecting the content device and the storage device;
wherein the storage device
receives attribute information of the content identified in the ticket;
determines whether the storage device has the content identified in the ticket based on the attribute information;
if the storage device does not have the content identified in the ticket, receives the content identified in the ticket from the content device and storing the content in the storage device; and
if the storage device has the content identified in the ticket, does not receive the content identified in the ticket from the content device.

9. A system according to claim 8,
wherein the storage device refers to a content management table which stores a content ID of each content stored in the storage device and one or more users who possess said each content, and determines whether the storage device has the content identified in the ticket based on the attribute information and the content management table; and
wherein the storage device updates the content management table using the trade information on the ticket.

10. A system according to claim 8, further comprising:
a client device connected to the network;
wherein the storage device receives the ticket from the content device which issues the ticket based on an order from the client device that provides, to the content device, information on the storage device for storing the content identified in the ticket.

11. A system according to claim 8, further comprising:
an authentication device connected to the network, the authentication device authenticating the user by providing billing information of the user to the content device prior to issuing the ticket by the content device.

12. A system according to claim 8,
wherein the storage device selects the content device from a plurality of content devices connected to the network which include one or more of content servers and cache servers that have the content identified in the ticket.

13. A system according to claim 12,
wherein the storage device selects the content device based on at least one of a bandwidth of the content device or a network distance between the content device and the storage device.

14. A system according to claim 8,
wherein the storage device receives from the content device a plurality of divided sub-contents that make up the content identified in the ticket.

15. A computer-readable storage medium storing a plurality of instructions for controlling a data processor to provide contents from a content device to a storage device, the plurality of instructions comprising:
instructions that cause the data processor to receive, by the storage device, a ticket including trade information of a trade by a user for content from the content device;
instructions that cause the data processor to request, by the storage device, attribute information of the content identified in the ticket from the content device;
instructions that cause the data processor to determine whether the storage device has the content identified in the ticket based on the attribute information;
if the storage device does not have the content identified in the ticket, instructions that cause the data processor to receive the content identified in the ticket from the content device and store the content in the storage device; and
if the storage device has the content identified in the ticket, instructions that cause the data processor not to receive the content identified in the ticket from the content device.

16. A computer-readable storage medium according to claim 15,
wherein the instructions that cause the data processor to determine comprise instructions that cause the data processor to refer to a content management table which stores a content ID of each content stored in the storage device and one or more users who possess said each content; and
wherein the plurality of instructions further comprise instructions that cause the data processor to update the content management table using the trade information on the ticket.

17. A computer-readable storage medium according to claim 15,
wherein the instructions that cause the data processor to receive the ticket comprise instructions that cause the data processor to receive the ticket from the content device which issues the ticket based on an order from a client device that provides, to the content device, information on the storage device for storing the content identified in the ticket.

18. A computer-readable storage medium according to claim 15, wherein the plurality of instructions further comprise:
instructions that cause the data processor to authenticate the user by providing billing information of the user to the content device prior to issuing the ticket by the content device.

19. A computer-readable storage medium according to claim 15, wherein the plurality of instructions further comprise:
instructions that cause the data processor to select the content device by the storage device from a plurality of content devices which include one or more of content servers and cache servers that have the content identified in the ticket.

20. A computer-readable storage medium according to claim 15,
wherein the instructions that cause the data processor to receive the content identified in the ticket comprise instructions that cause the data processor to receive a plurality of divided sub-contents that make up the content.
